(19) United States
(12) Patent Application Publication
(10) Pub. No.: US 2015/0164050 A1
(43) Pub. Date: Jun. 18, 2015

(54) Animal Control Device with an Anti-Slip Friction Holding Mechanism

(71) Applicant: Richard Kane Robertson, Kaufman, TX (US)

(72) Inventor: Richard Kane Robertson, Kaufman, TX (US)

(21) Appl. No.: 14/107,628

(22) Filed: Dec. 16, 2013

(51) Int. Cl. A01K 27/00

(52) U.S. Cl. CPC A01K 27/003; A01K 27/001

(57) ABSTRACT

An animal control device with an anti-slip friction holding mechanism which allows the length of the loop to be easily changed and eliminated the need for attaching a animal control devices to buckles or similar mechanisms. Some of device uses are to substitutes for leashes or collars as well as hobbling devices, with a device that can be easily adjusted for size to be used on multiple animals. In accordance with one embodiment a woven rope type product has an additional woven rope type sleeve(s) woven into the end of one or both ends of the rope structure so that the end of the rope can be looped back through the sleeve. This allows the loop made by doubling back the rope type material to adjustable in size.

### BACKGROUND

### Prior Art

U.S. Patents

| Patent number | Kind Code | Issue Date | Patentee |
|---|---|---|---|
| 5,749,127 A | A | May 12, 1998 | Hsing-Chi Hsieh |
| 6,715,449 B1 | B1 | Apr. 6, 2004 | Mark J Jordan |
| 7,454,932 B2 | B2 | Nov. 25, 2008 | Clinton Hollier |

US Patent Application Publications

| Publication number | Kind Code | Publication Date | Applicant |
|---|---|---|---|
| WO2011107725 A2 | A2 | Sep. 9, 2011 | John Finlan |
| WO2009121146 A1 | A1 | Oct. 8, 2009 | Michael Nevers |
| WO2008155791 A1 | A1 | Dec. 24, 2008 | Carlo Vaccari |

Pets that need to be walked are usually accompanied using leads provided with a part to be held by the person walking the pet, and a device on the other end which constrains the pet sometimes a spring clip type for attaching the lead to a collar or harness, or some other fastening device. Somewhat similar product are ones that hobble livestock so they can't easily run or walk fast, with one end part attached to one leg and the other end part attached to the other leg.

Traditional collars for pets that need to be walked comprise a strap with ends that can be joined by a wide variety of suitable means to form a circle designed to be wrapped around the neck, in the case of a dog collar, or the chest and back area, in the case of a dog harness. In the case of hobbling an animal, each ends need to be attached to one leg of the animal.

The collar also comprises a ring so that it can be attached to a spring clip that can be fixed to the cord of a lead so that the person walking the pet can always keep the animal under complete and secure control when walking Devices for hobbling animals also consist of a wide variety of clamping parts, including but not limited to clasps, clips, fastening, or bayonet fastening and buckles.

A drawback of traditional collars and hobbling devices is that they have moving parts that need to engaged to fasten or adjust the holding device so that is comfortable for the animal while not slipping off of the animal.

Another drawback is that the holding devices often need to be taken off of the animal in order to be properly adjusting, which can be difficult to execute if the animal is an excited state.

From a retailer point of view, most designs for holding pets, either collars, harness of ankle hobbling devices fit only a narrow size range of animal, requiring the retail to stock many items. This is inefficient for the retailer and it can also require an animal owner to purchase new holding devices when they add new animals that are a different size than current animals.

### SUMMARY

In accordance with one embodiment a woven rope type product has an additional woven rope type sleeve(s) woven into the end of one or both ends of the rope structure so that the end of the rope can be looped back through the sleeve. This allows the loop made by doubling back the rope type material to adjustable in size. When sized properly the sleeve can be pulled down to lock the loop in place. When the end of the loop closest to the rope device is pulled away from the sleeve the sleeve releases and the loop can then be adjusted in size. The sleeve can also be released by pushing the end of the sleeve furthest from the loop towards the loop.

### Advantages

The rope type product consists only of the rope type material and thermo setting plastic which secures the end. There are no moving mechanical parts such as buckles or clips of any sort. The product can be easily adjusted while on the animal, adjusted anytime during the life of the product, and can be adjusted to accommodate a large variety of size animals. One embodiment of the product allows for the loops on both ends to be adjusted so the product can be used to hobble large animals. The lack of moving mechanical parts also eliminates injuries that animals might receive from those moving parts.

### DRAWINGS—FIGURES

FIG. 1 shows the device with the woven rope type sleeve portion 3 in the pulled down position locking the loop portion 5 into a fixed position.

FIG. 2 show the device with the woven rope type sleeve portion 3 pulled together into a loose configuration so that the loop portion of the device 5 can be either made smaller by pulling down on the rope type device anywhere along the rope section 1.

FIG. 3 shows the device with the woven rope type sleeve portion 3 pulled together into a loose configuration so it can create a larger loop by pulling on the rope type device at the opposite side 8 of the thermal plastic holding devices that keeps the loop from being totally eliminated.

FIG. 4 points out where the ends of the rope type material ends. On the end of the rope with the fixed loop, the end 6 in inside of the thermal setting device. On the end with the adjustable loop, the woven rope type sleeved end of the rope type device 9 ends close to the end of the thermosetting plastic 2 so that the rope type device can slide freely between smaller and large configurations.

FIG. 5 is another embodiment where both ends of the rope type device have ends that are adjustable.

### DETAILED DESCRIPTION

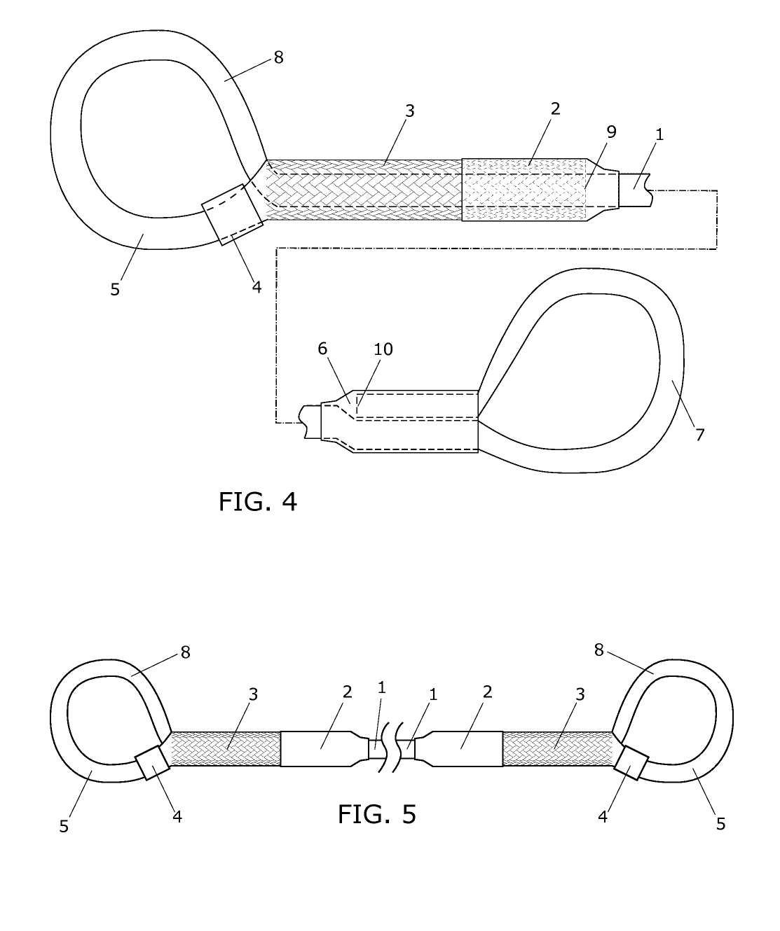

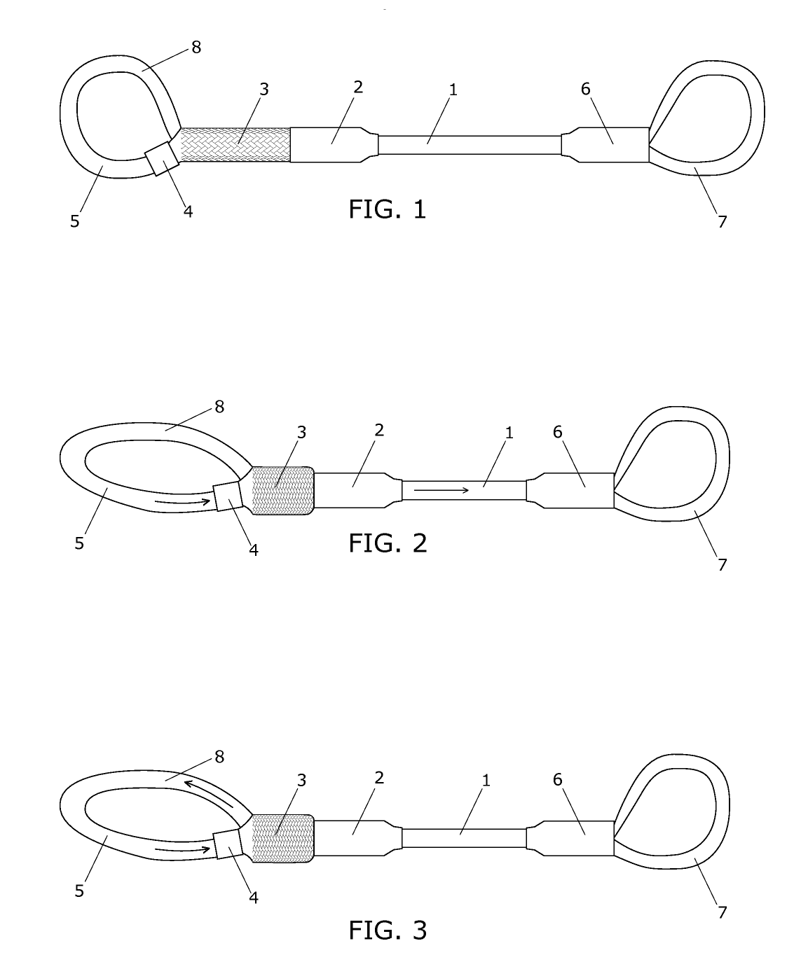

### FIGS. 1-4 First Embodiment

This embodiment has one end with the loop size fixed. The end of the rope like device 10 makes a loop and the end of the rope like device is held in place with the remaining rope by a thermosetting plastic 6. FIG. 4 shows the end of the rope like device 10 inside the thermosetting plastic but other embodiments could have the end of the rope past the end of the thermosetting plastic. FIG. 4 also shows the rope device being two separate pieces of rope like devices. Another embodiment would have a sleeve, similar to sleeve 3 that the solid end slips through the sleeve and then is held in place by a thermosetting plastic.

The end of the rope with the adjustable loop has a piece of thermosetting plastic 4 at the base of the loop to ensure the loop is always open. At a distance away from the end of the rope like device the rope has a woven rope type sleeve 3, or in another embodiment the rope like device has a hollow core inside of a woven rope like sleeve, big enough that the end of the rope can slide through and still allow the sleeve to be pulled down to reduce the diameter so the sleeve holds the rope in place when the loop 5 is the desired size. A thermosetting plastic sleeve 2 fits over the rope like sleeve 3 with thermosetting sleeve protruding only a small distance below the end of the woven rope like sleeve in order that the thermosetting plastic holds then end permanently in place while not impeding the pulling of the woven rope like device to either make the loop 5 bigger or smaller. When the user desires to change the size of the loop, the rope like device is pulled at point 8 away from the thermosetting plastic sleeve 2 to make the woven rope like sleeve 3 loose, which also makes the loop bigger, but also acts to bunch the sleeve up so that the rope like device can be pulled either at 8 to make the loop bigger, or a point 1 to make the loop smaller. Once the loop 5 is at the desired size, the user places their hand on the sleeve 3 and pulls it away from the loop 5 to make the sleeve smaller so the loop is held in place.

### FIG. 5—Second Embodiment

FIG. 5 shows a second embodiment with two adjustable loops 5 on both ends rather than an adjustable loop 5 on one end and a non-adjustable loop 7 on the other end. The adjustable end in this embodiment works the same as the adjustable loop end in the first embodiment.

I claim:

1. A rope like device for controlling animals comprising a woven rope like sleeve incorporated into a section of the woven rope like device a certain distance from the end or a woven rope like that allows the end of the woven rope like device to be threaded through the sleeve.

2. The device of claim one with a thermosetting plastic sleeve set near the end of woven rope type sleeve positioned so that it holds the one end of woven rope type device end in place while still allowing the a portion of the woven rope type device to be threaded through the sleeve.
